(19) United States
(12) Patent Application Publication
(10) Pub. No.: US 2009/0258679 A1
(43) Pub. Date: Oct. 15, 2009

(54) APPARATUS AND METHOD FOR ENHANCING TRANSMISSION SPEED OF A MOBILE PHONE

(75) Inventor: Chun-An CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/241,091

(22) Filed: Sep. 30, 2008

(30) Foreign Application Priority Data
Apr. 11, 2008 (CN) 200810301105.5

(51) Int. Cl. H04M 1/00

(52) U.S. Cl. 455/557; 455/571

(57) ABSTRACT

A transmission speed enhancing apparatus of a mobile phone is disclosed. The apparatus comprises a processor having a secure digital input/output (SDIO) interface and a GPIO interface, a WiFi module and a secure digital memory A SDIO switcher is configured for disconnecting the SDIO interface with the secure digital memory when receiving a switching command from the general purpose input/output interface of the processor, and connecting the SDIO interface with the WiFi module so as to enhance the transmission speed of the mobile phone. A method for enhancing transmission speed of a mobile phone is also disclosed.

### BACKGROUND

1. Field of the Invention

Embodiments of the present disclosure relate to apparatus and methods for enhancing transmission speed, and particularly to a system and method for enhancing transmission speed of a mobile phone.

2. Description of Related Art

Currently, mobile phones have many advanced functions including advanced auxiliary functions. The auxiliary functions of the mobile phones typically include such things as phone book systems, ring tones, network settings, short message services, and wireless transmission.

A popular wireless transmission manner of the mobile phones is to install a Bluetooth or a WiFi module in the mobile phones. For example, FIG. 1 is a block diagram of a conventional apparatus for enhancing transmission speed of a mobile phone. A WiFi module 5 is connected with a processor 2 via a serial peripheral interface 11. The processor 2 may be, but not limited to, an Advanced Risc Machine (ARM). A secure digital memory 6 is connected with the processor 2 via a secure digital input/output (SDIO) interface 12. The WiFi module 5 is a wireless network based on the Institute of Electrical and Electronics Engineers (IEEE) 802.11b standard, which can transmit data fleetly in a longer transmission distance. Generally, the serial peripheral interface 11 has a transmission speed of 13 Mbit/s, and the SDIO interface 12 has a transmission speed of 192 Mbit/s. However, the SDIO interface 12 cannot be connected to the WiFi module 5 directly. Therefore, the transmission speed is limited.

What is needed, therefore, is an apparatus and method for enhancing transmission speed of the mobile phone to overcome the above-stated problems and enhance the transmission speed.

### SUMMARY

In one aspect, the aforementioned needs are satisfied by a transmission speed enhancing apparatus of a mobile phone. The apparatus comprises a processor having a secure digital input/output (SDIO) interface and a general purpose input/output (GPIO) interface; a WiFi module; a secure digital memory connecting with SDIO interface via a SDIO switcher; the SDIO switcher configured for disconnecting the SDIO interface with the secure digital memory when receiving a switching command from the GPIO interface of the processor, and connecting the SDIO interface with the WiFi module so as to enhance transmission speed of the mobile phone.

Other objects, advantages and novel features will become more apparent from the following detailed description of certain embodiments of the present disclosure when taken in conjunction with the accompanying drawings, in which:

### BRIEF DESCRIPTION OF THE DRAWINGS

FIG. 1 is a block diagram of a conventional apparatus for enhancing transmission speed.

FIG. 2 is a block diagram of one embodiment of a mobile phone including a transmission speed enhancing apparatus.

FIG. 3 is a flowchart of one embodiment of a method for enhancing transmission speed of the mobile phone.

### DETAILED DESCRIPTION OF CERTAIN INVENTIVE EMBODIMENTS

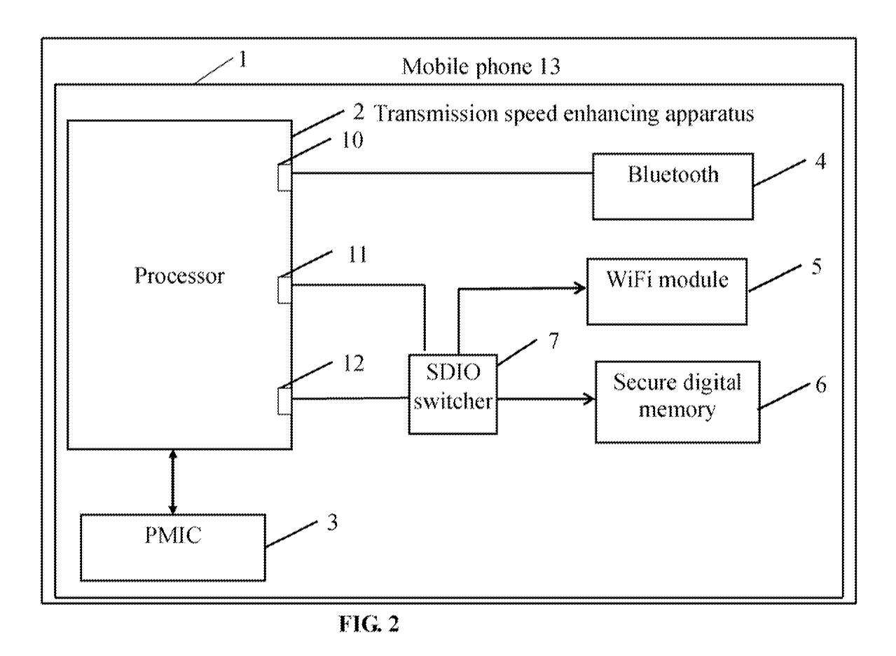

FIG. 2 is a block diagram of one embodiment of a mobile phone 13 comprising a transmission speed enhancing apparatus (hereinafter “the apparatus”) 1. The apparatus 1 is configured for enhancing the transmission speed of the mobile phone 1. As used herein, the term transmission speed is a speed that the mobile phone 1 with WiFi can communicate (e.g. send/receive data packets) with another phone with WiFi. In one embodiment, the apparatus 1 includes a processor 2, a power manage integrated circuit (PMIC) 3, a secure digital memory 6, and a SDIO switcher 7. The secure digital memory 6 is connected with the processor 2 via the SDIO switcher 7. The SDIO switcher 7 is connected with the processor 2 via a general purpose input/output (GPIO) interface 11 and a SDIO interface 12 of the processor 2. If the WiFi module 5 needs to be utilized, a switching command is sent to the processor 2 via a manual input operation. The processor 2 sends the switching command via the GPIO interface 11 to the SDIO switcher 7. And the SDIO switcher 7 disconnects the SDIO interface 12 with the secure digital memory 6 and connects the SDIO interface 12 to the WiFi module 5. Thus, the WiFi module 5 may transmit data faster due to a connection with the SDIO interface 12, thereby enhancing the transmission speed of the mobile phone 13. The processor 2 may be an Advanced Risc Machine processor in one embodiment, but the present disclosure is not limited thereto.

The apparatus 1 may include a bluetooth 4 which is connected with the processor 2 through a universal asynchronous receiver/transmitter or a pulse code modulation of the processor 2. Bluetooth 4 is a short-distance wireless technology having following technical characteristics: license-free 2.4 GHz frequency band; 400 kbps of data symmetrically or 700 to 150 kbps of data asymmetrically; range approximately 10 m at 1 mW transmitting power, approximately 100 m (in the open) at 100 mW. The apparatus 1 further includes a power manage integrated circuit (PMIC) 3, which is connected with the processor 2 for supplying power to assure credible operations of the processor 2.

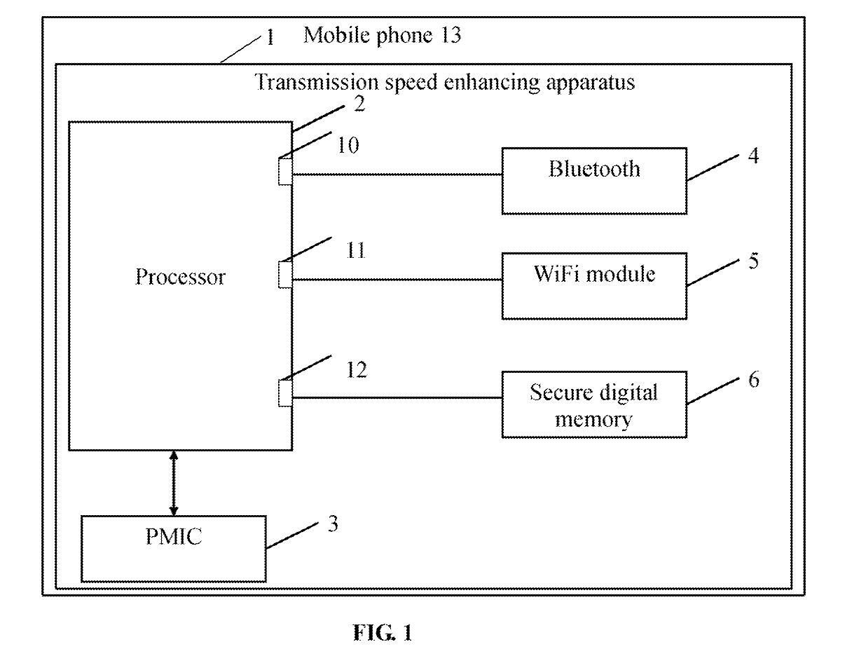

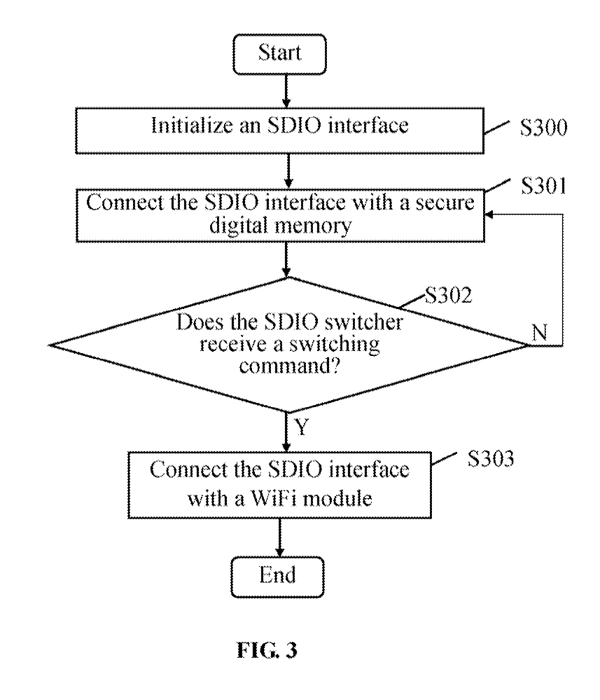

FIG. 3 is a flowchart of one embodiment of a method for enhancing transmission speed of the mobile phone by using the apparatus 1 in FIG. 1. Depending on the embodiment, additional blocks may be added, others deleted, and the ordering of the blocks may be changed. In block S300, the processor 2 initializes the SDIO interface 12 when the mobile phone 13 is powered on.

In block S301, the SDIO interface 12 is connected with the secure digital memory 6.

In block S302, the processor 2 determines if it has received a switching command. If the processor 2 does not receive a switching command, the procedure goes back to block S301. Otherwise, if the processor 2 receive the switching command, the procedure goes to block S303.

In block S303, the processor 2 sends the switching command to the SDIO switcher 7 via the GPIO interface 11. The SDIO switcher disconnects the SDIO interface 12 from the secure digital memory 6 and connects the SDIO interface 12 with the WiFi module 5 so as to enhancing the transmission speed of the mobile phone 13.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An apparatus for enhancing transmission speed of a mobile phone, the apparatus comprising:
a processor having a secure digital input/output (SDIO) interface and a general purpose input/output (GPIO) interface;
a WiFi module;
a secure digital memory connecting with SDIO interface via a SDIO switcher;
the SDIO switcher configured for disconnecting the SDIO interface with the secure digital memory when receiving a switching command from the GPIO interface of the processor, and connecting the SDIO interface with the WiFi module so as to enhance transmission speed of the mobile phone.

2. The apparatus as claimed in claim 1, wherein the SDIO interface has a transmission speed of about 192 Mbit/s.

3. The apparatus as claimed in claim 1, wherein the processor is an Advanced Risc Machine (ARM) processor.

4. The apparatus as claimed in claim 1, further comprising a Bluetooth receiver and a Bluetooth transmitter connecting with the processor.

5. A method for enhancing transmission speed of a mobile phone, the mobile phone comprising a processor having a secure digital input/output (SDIO) interface and a general purpose input/output (GPIO) interface, a WiFi module and a secure digital memory, the method comprising:
providing a SDIO switcher and connecting the SDIO interface with the secure digital memory;
sending a switching command from the processor to the SDIO switcher via the GPIO interface; and
disconnecting the SDIO interface with the secure digital memory when the SDIO switcher receives the switching command, and connecting the SDIO interface with the WiFi module so as to enhancing transmission speed of the mobile phone.

6. The method as claimed in claim 5, wherein the SDIO interface has a transmission speed of about 192 Mbit/s.

7. The method as claimed in claim 5, wherein the processor is an Advanced Risc Machine.

8. The method as claimed in claim 5, wherein the mobile phone comprises a Bluetooth receiver and a Bluetooth transmitter connecting with the processor.

9. A storage medium having stored thereon instructions that, when executed by a mobile phone, cause the mobile phone to perform a method for enhancing transmission speed of the mobile phone, the mobile phone comprising a processor having a secure digital input/output (SDIO) interface and a general purpose input/output (GPIO) interface, a WiFi module and a secure digital memory, the method comprising:
providing a SDIO switcher and connecting the SDIO interface with the secure digital memory;
sending a switching command from the processor to the SDIO switcher via the GPIO interface; and
disconnecting the SDIO interface with the secure digital memory when the SDIO switcher receives the switching command, and connecting the SDIO interface with the WiFi module so as to enhancing transmission speed of the mobile phone.

10. The storage medium as claimed in claim 9, wherein the SDIO interface has a transmission speed of 192 Mbit/s.

11. The method as claimed in claim 9, wherein the processor is an Advanced Risc Machine.

12. The method as claimed in claim 9, wherein the mobile phone comprises a Bluetooth receiver and a Bluetooth transmitter connecting with the processor.
